(19) United States
(12) Patent Application Publication
(10) Pub. No.: US 2024/0069377 A1
(43) Pub. Date: Feb. 29, 2024

(54) LIGHT GUIDE COMPONENT, DISPLAY DEVICE, AND METHOD FOR MANUFACTURING DISPLAY DEVICE

(71) Applicants: Beijing BOE Display Technology Co., Ltd., Beijing (CN); BOE TECHNOLOGY GROUP CO., LTD., Beijing (CN)

(72) Inventors: Changjia FU, Beijing (CN); Dan LI, Beijing (CN); Haijun SHI, Beijing (CN); Bochang WANG, Beijing (CN); Enliang ZHANG, Beijing (CN)

(73) Assignees: Beijing BOE Display Technology Co., Ltd., Beijing (CN); BOE TECHNOLOGY GROUP CO., LTD., Beijing (CN)

(21) Appl. No.: 18/271,286

(22) PCT Filed: Mar. 11, 2022
(86) PCT No.: PCT/CN2022/080393

§ 371 Date: Jul. 7, 2023

(30) Foreign Application Priority Data
Jun. 22, 2021 (CN) 202110690919.8

(51) Int. Cl. G02F 1/1335; G02F 1/1333

(52) U.S. Cl. CPC G02F 1/133524; G02F 1/13336

(57) ABSTRACT

A light guide component, a display device, a method for manufacturing the display device are provided. The light guide component includes an upper light guide portion including a light-emission surface and a refraction surface, and a lower light guide portion including a light incident surface and a reflection surface. The light guide component is configured to: allow a first deflected light entering the light incident surface to be projected onto one of the refraction surface and the light-emission surface, refracted by one of the refraction surface and the light-emission surface and emitted out of the light guide component; and allow a second deflected light entering the light incident surface to be projected onto the reflection surface, reflected to one of the refraction surface and the light-emission surface by the reflection surface, refracted by one of the refraction surface and the light-emission surface and emitted out of the light guide component.

### CROSS-REFERENCE TO RELATED APPLICATION

The present application claims the priority to Chinese patent application No. 202110690919.8, filed on Jun. 22, 2021, the entire disclosure of which is incorporated herein by reference as portion of the present application.

### TECHNICAL FIELD

Embodiments of the present disclosure relate to a light guide component, a display device including the light guide component, and a method for manufacturing the display device.

### BACKGROUND

With the rapid development of flat-panel display technology, size and application scenario of the flat-panel display device are constantly expanding, and large-size application scenario of the flat-panel display have emerged. The size of a single display panel is limited, and the larger the size of the single display panel is, the higher the production and transportation costs are. In some cases, a plurality of display panels are spliced with each other to form a spliced display panel with a larger size. However, in the spliced display panel, a splicing seam exists between adjacent display panels, and the splicing seam adversely affect the viewing experience of the user.

### SUMMARY

At least one embodiment of the disclosure provides a light guide component. The light guide component comprises: an upper light guide portion, comprising a light-emission surface and a refraction surface; and a lower light guide portion, arranged opposite to the upper light guide portion, and the lower light guide portion comprising a light incident surface and a reflection surface. The light-emission surface and the light incident surface are arranged substantially parallel to each other, and the refraction surface and the reflection surface are respectively arranged at an edge of the light guide component. The light guide component is configured to allow a first deflected light entering the light incident surface to be projected onto one of the refraction surface and the light-emission surface, refracted by one of the refraction surface and the light-emission surface and emitted out of the light guide component; and the light guide component is configured to allow a second deflected light entering the light incident surface to be projected onto the reflection surface, reflected to one of the refraction surface and the light-emission surface by the reflection surface, refracted by one of the refraction surface and the light-emission surface and emitted out of the light guide component.

For example, in one or more embodiments of the disclosure, the light guide component is configured such that: upon observing each point on the light-emission surface and the refraction surface on a side where the upper light guide portion is located in a viewing angle smaller than a first threshold angle, at least one of the first deflected light and the second deflected light is observed.

For example, in one or more embodiments of the disclosure, the light guide component is in a shape of a flat plate.

For example, in one or more embodiments of the disclosure, the light guide component extends in an extension direction with a cross section of the light guide component keeping constant; and in the cross section of the light guide component, the refraction surface presents as a convex curve line segment.

For example, in one or more embodiments of the disclosure, in the cross section of the light guide component, the refraction surface extends continuously from the light-emission surface, the refraction surface presents as a continuous curve line segment, and angles of tangent lines at respective points of the refraction surface with respect to an extension line of the light-emission surface gradually increase from the light-emission surface to the light incident surface.

For example, in one or more embodiments of the disclosure, in the cross section of the light guide component, the refraction surface presents as a single arc segment.

For example, in one or more embodiments of the disclosure, a radius of the single arc segment is in a range of 2 mm-10 mm.

For example, in one or more embodiments of the disclosure, in the cross section of the light guide component, the refraction surface presents to comprise a plurality of arc segments, and a diameter of an arc segment far away from the light-emission surface is larger than a radius of an arc segment close to the light-emission surface.

For example, in one or more embodiments of the disclosure, in the cross section of the light guide component, the plurality of arc segments comprise a third arc segment, a second arc segment and a first arc segment which are provided sequentially far away from the light-emission surface, a radius of the first arc segment is smaller than a radius of the second arc segment, and the radius of the second arc segment is smaller than a radius of the third arc segment.

For example, in one or more embodiments of the disclosure, radiuses of the plurality of arc segments are respectively in a range of 2 mm-20 mm.

For example, in one or more embodiments of the disclosure, in a cross section of the light guide component, the reflection surface presents as a single straight line segment, a convex arc segment, or a concave arc segment.

For example, in one or more embodiments of the disclosure, the reflection surface comprises a totally reflection surface.

For example, in one or more embodiments of the disclosure, in a cross section of the light guide component, an overall thickness of the light guide component is in a range of 5 mm-20 mm, and the overall thickness is a distance between the light-emission surface and the light incident surface.

For example, in one or more embodiments of the disclosure, in a cross section of the light guide component, a first width of the refraction surface is in a range of 2 mm-10 mm, a first thickness of the refraction surface is in a range of 2 mm-8 mm, the first width is a distance that the reflection surface extends in a direction parallel to the light incident surface, and the first thickness is a distance that the reflection surface extends in a direction perpendicular to the light incident surface.

For example, in one or more embodiments of the disclosure, in a cross section of the light guide component, a second width of the reflection surface is in a range of 0.64 mm-2.15 mm, a second thickness of the reflection surface is in a range of 2 mm-16 mm, the second width is a distance that the reflection surface extends in a direction parallel to the light incident surface, and the second thickness is a distance that the reflection surface extends in a direction perpendicular to the light incident surface.

For example, in one or more embodiments of the disclosure, the light guide component further comprises an abutment surface, the abutment surface is connected between the refraction surface and the reflection surface and is perpendicular to the light-emission surface and the light incident surface, so that the light guide component and an adjacent light guide component abut against each other through the abutment surface.

For example, in one or more embodiments of the disclosure, a length of the abutment surface is in a range of 0.3 mm-1 mm.

At least one embodiment of the disclosure provides a display device, comprising: a plurality of display panels and the light guide component as described above. The splicing seam that does not emit light is provided between two adjacent display panels. The light guide component is provided on a display side of each of the plurality of display panels, so that the light incident surface is attached to the display panel, the refraction surface and the reflection surface are close to the splicing seam, two adjacent light guide components are arranged symmetrically with respect to the splicing seam, and an orthographic projection of the reflection surface on a display plane of the display panel completely covers the splicing seam.

For example, in one or more embodiments of the disclosure, the splicing seam comprises a plurality of bezels, each bezel surrounds one of the plurality of display panels, and each bezel comprises a first bezel segment surrounding the display panel and extending perpendicular to the display plane of the display panel, a second bezel segment extending from the first bezel segment toward an interior of the display panel, and a third bezel segment extending from the second bezel segment toward the interior of the display panel; and the second bezel segment and the third bezel segment are on the display side of the display panel, the reflection surface abuts against the third bezel segment, and a bezel bent angle between the third bezel segment and the display plane is equal to an angle of the light guide component between the light incident surface and the reflection surface.

For example, in one or more embodiments of the disclosure, the light guide component further comprises an abutment surface, the abutment surface is connected between the refraction surface and the reflection surface and is perpendicular to the light-emission surface and the light incident surface, and two adjacent light guide components abut against each other through the abutment surface. The splicing seam comprises a plurality of bezels, each bezel surrounds one of the plurality of display panels, and each bezel comprises a first bezel segment surrounding the display panel and extending in the display plane of the display panel.

For example, in one or more embodiments of the disclosure, in a cross section of the light guide component, a second width of the reflection surface is in a range of L0/2 mm to (L0/2+0.2) mm, and L0 is a width of the splicing seam.

For example, in one or more embodiments of the disclosure, in a cross section of the light guide component, the refraction surface presents as a single arc segment, a radius of the single arc segment is in a range of (L0/2+0.5) mm to (L0/2+9) mm, and L0 is a width of the splicing seam.

For example, in one or more embodiments of the disclosure, the display panel is a liquid crystal display panel.

At least one embodiment of the disclosure provides a method for manufacturing the display device as described above, and the method comprises: providing the plurality of display panels, in which the splicing seam that does not emit light is formed between two adjacent display panels; providing the light guide component; and attaching the light guide component onto the display side of the display panel, so that the reflection surface abuts against the third bezel segment to position the light guide component with respect to the display panel.

At least one embodiment of the disclosure provides a method for manufacturing the display device as described above, and the method comprises: providing the plurality of display panels, in which the splicing seam that does not emit light is formed between two adjacent display panels; providing the light guide component; and attaching the light guide component onto the display side of the display panel, so that the abutment surface is aligned with the first bezel segment to position the light guide component with respect to the display panel.

### BRIEF DESCRIPTION OF DRAWINGS

In order to clearly illustrate the technical solutions of the embodiments of the present disclosure, the drawings of the embodiments will be briefly described. It should be noted that the described drawings in the following are only related to some embodiments of the present disclosure and thus are not limitative of the present disclosure. For those skilled in the art, other related drawings can be obtained according to these drawings without inventive work.

FIG. 1 illustrates a schematic plan view of a display panel;

FIG. 2 illustrates a cross-sectional view at a splicing seam of a display device formed by splicing at least two display panels;

FIG. 3 illustrates a cross-sectional view of a part of two light guide components arranged adjacent to and spliced with each other according to embodiments of the present disclosure;

FIG. 4 and FIG. 5 respectively illustrate cross-sectional views of a part of a display device including the two light guide components illustrated in FIG. 3, FIG. 4 illustrates a plurality of first deflected lights, and FIG. 5 illustrates a plurality of second deflected lights;

FIG. 6 illustrates another cross-sectional view of a part of the two light guide components in FIG. 3, in which two incident lights respectively incident on the refraction surface are illustrated;

FIG. 7 illustrates another cross-sectional view of a part of the two light guide components in FIG. 3, in which an incident light incident at a connection point between the refraction surface and a light-emission surface is illustrated;

FIG. 8 illustrates another cross-sectional view of a part of the two light guide components in FIG. 3, in which another incident light incident at the connection point between the refraction surface and the light-emission surface is illustrated;

FIG. 9 illustrates a table representing the relationship between the refractive index, the viewing angle, and the angle of the light guide component in the case where the reflection surface is a non-totally reflection surface;

FIG. 10 illustrates a table representing the relationship between the refractive index, the viewing angle, and the angle of the light guide component in the case where the reflection surface is a totally reflection surface;

FIG. 11A-FIG. 11C respectively illustrate optical path simulation diagrams of the light guide component under different widths of the splicing seam, different viewing angles, different second thicknesses and different second widths in the case where the reflection surface is the non-totally reflection surface;

FIG. 12A-FIG. 12F respectively illustrate optical path simulation diagrams of the light guide component under different widths of the splicing seam, different viewing angles, different second thicknesses and different second widths in the case where the reflection surface is a totally reflection surface;

FIG. 13 illustrates another cross-sectional view of a part of the light guide component according to the embodiments of the present disclosure;

FIG. 14 illustrates yet another cross-sectional view of a part of the light guide component according to the embodiments of the present disclosure;

FIG. 15 illustrates still another cross-sectional view of a part of the light guide component according to the embodiments of the present disclosure;

FIG. 16 illustrates another cross-sectional view of a part of the display device according to the embodiments of the present disclosure;

FIG. 17 illustrates a cross-sectional view of a bezel and a spacer in FIG. 16;

FIG. 18 illustrates a flowchart for manufacturing the display device illustrated in FIG. 16;

FIG. 19 illustrates another cross-sectional view of the display device illustrated in FIG. 16, which illustrates a process of installing the light guide component;

FIG. 20 illustrates yet another cross-sectional view of a part of the display device according to the embodiments of the present disclosure;

FIG. 21 illustrates a flowchart for manufacturing the display device illustrated in FIG. 20; and

FIG. 22 illustrates another cross-sectional view of the display device illustrated in FIG. 20, which illustrates a process of installing the light guide component.

### DETAILED DESCRIPTION

Hereinafter, a light guide component, a display device including the light guide component, and a method for manufacturing the display device according to the embodiments of the present disclosure will be described in detail with reference to the drawings. In order to make objects, technical details and advantages of the embodiments of the present disclosure apparent, the technical solutions of the embodiments will be described in a clearly and fully understandable way in connection with the drawings related to the embodiments of the disclosure. Apparently, the described embodiments are just a part but not all of the embodiments of the present disclosure.

Accordingly, the following detailed description of the embodiments of the present disclosure, provided in conjunction with the drawings, is not intended to limit the claimed scope of the disclosure, but merely represents selected embodiments of the present disclosure. Based on the embodiments in the present disclosure, all other embodiments obtained by those skilled in the art without inventive work fall within the claimed scope of the present disclosure.

A singular form includes a plural form unless the context defines otherwise. Throughout the specification, the terms “include,” “comprise,” “have,” etc. are used herein to designate the presence of features, numbers, steps, operations, elements, components or combinations thereof, but do not exclude the presence or addition of one or more other features, numbers, steps, operations, elements, components or combinations thereof.

In addition, even though the terms of ordinal numbers such as ‘first,’ ‘second,’ etc. are used to describe various components, these components are not limited by these terms, and these terms are only used to distinguish one element from other elements.

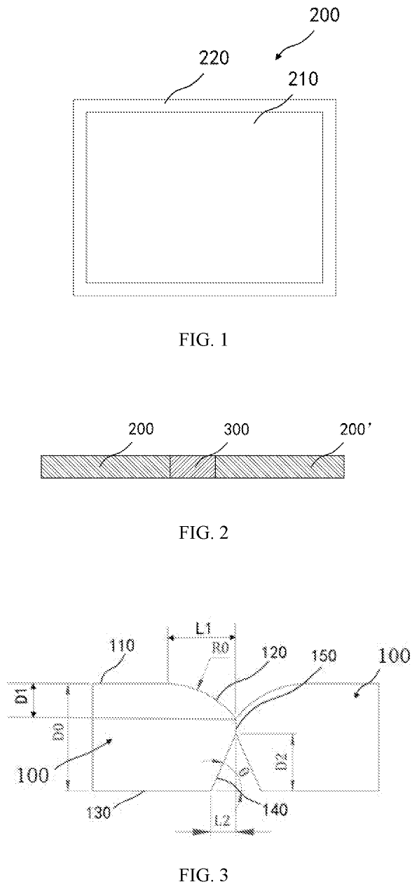

FIG. 1 illustrates a schematic plan view of a display panel 200. As illustrated in FIG. 1, the display panel 200 includes a light-emission portion 210 and a non-light-emission portion 220 at least partially surrounding the light-emission portion 210. The light-emission portion 210 emits a display light for display while the non-light-emission portion 220 does not emit the display light, and the non-light-emission portion 220 for example is a bezel portion surrounding a display region. Here, a “display side” of the display panel 200 is defined as a side on which the display panel 200 emits the display light. The display panel 200 for example is a liquid crystal display (LCD) panel. An exemplary liquid crystal display panel includes a liquid crystal layer, a color filter (for example, a color filter substrate) and a first polarizer sequentially arranged on a side of the liquid crystal layer, and an array substrate and a second polarizer sequentially arranged on the other side of the liquid crystal layer; and if necessary, a backlight unit and the like is further provided for the liquid crystal display panel. In addition, the liquid crystal display panel further includes a circuit board, a bezel for protecting the display panel, etc., and the bezel is usually arranged on edges of the liquid crystal display panel to form the non-light-emission portion 220 and the like. In addition, the display panel 200 for example is a plasma display panel (PDP), a light-emission diode (LED) display panel, an organic light-emission diode (OLED) display panel, a quantum-dot light-emission diode (QLED) display panel, and the like.

FIG. 2 illustrates a cross-sectional view at a splicing seam (splicing position) of a display device formed by splicing at least two display panels 200, 200′. As illustrated in FIG. 2, the display device includes a first display panel 200, a second display panel 200′, and a splicing seam 300 between the first display panel 200 and the second display panel 200′. For example, the first display panel 200 has the same specifications (such as the same size and configuration) as the second display panel 200′, but the embodiments of the present disclosure are not limited thereto. It should be understood that the splicing seam 300 for example includes the non-light-emission portion 220 of the display panel 200 and the non-light-emission portion of the display panel 200′. Here, only two display panels 200, 200′ are illustrated to be spliced with each other as an example.

It should be understood that in the embodiments of the present disclosure, the total number of display panels 200, 200′ to be spliced may be greater than 2, and the plurality of display panels 200 may be arranged in a straight line, in an array or in other patterns. Because the splicing seam 300 is between adjacent display panels 200, 200′, a dark region caused by the splicing seam 300 exists in the image displayed by the display device, which affects the viewing experience of the viewer. Therefore, the splicing seam 300 needs to be eliminated.

Herein, “eliminating” the splicing seam refers to allowing the viewer unable to visually and subjectively observe the splicing seam or the dark region caused by the splicing seam when viewing the display image on the display side of the display device.

Some embodiments of the present disclosure provide a light guide component, and the light guide component includes an upper light guide portion and a lower light guide portion arranged opposite to the upper light guide portion. The upper light guide portion includes a light-emission surface and a refraction surface. The lower light guide portion includes a light incident surface and a reflection surface. The light-emission surface and the light incident surface are arranged substantially parallel to each other. The refraction surface and the reflection surface are respectively arranged at an edge of the light guide component. The light guide component is configured to allow a first deflected light entering the light incident surface to be projected onto one of the refraction surface and the light-emission surface, refracted by one of the refraction surface and the light-emission surface and emitted out of the light guide component; and the light guide component is further configured to allow a second deflected light entering the light incident surface to be projected onto the reflection surface, reflected to one of the refraction surface and the light-emission surface by the reflection surface, refracted by one of the refraction surface and the light-emission surface and emitted out of the light guide component.

Herein, “viewing angle” refers to an angle between a line of sight and a display direction, and the display direction is a direction perpendicular to the light guide component or a display plane of the display panel. The light guide component is configured such that the first deflected light entering the light incident surface is projected onto one of the refraction surface and the light-emission surface, refracted by one of the refraction surface and the light-emission surface and emitted out of the light guide component, and thus in a smaller viewing angle, the light guide component refracts a light emitted by a light-emission portion of the display panel adjacent to a splicing seam to be above the splicing seam. In addition, the light guide component is configured such that the second deflected light entering the light incident surface is projected onto the reflection surface, reflected to one of the refraction surface and the light-emission surface by the reflection surface, refracted by one of the refraction surface and the light-emission surface and emitted out of the light guide component, and thus in a larger viewing angle, the light guide component reflects and refracts the light emitted by the light-emission portion of the display panel adjacent to the splicing seam and emits the light in a large angle. Therefore, in terms of subjective observation, the luminous intensity at the splicing seam is increased within a certain viewing angle (even within all viewing angles), thereby visually eliminating the splicing seam.

The configuration of the light guide component according to the embodiments of the present disclosure is described in more detail below.

FIG. 3 illustrates a cross-sectional view of a part of two light guide components 100 arranged adjacent to and spliced with each other according to the embodiments of the present disclosure. The two light guide components 100 each extend in a direction perpendicular to the paper surface with the cross section of the light guide component as illustrated in FIG. 3 keeping constant. As illustrated in FIG. 3, the light guide component 100 includes an upper light guide portion, a lower light guide portion arranged opposite to the upper light guide portion, and an abutment surface 150 connecting the upper light guide portion and the lower light guide portion at an edge of the light guide component. The upper light guide portion includes a light-emission surface 110 and a refraction surface 120. The lower light guide portion includes a light incident surface 130 parallel to the light-emission surface 110 and a reflection surface 140. The abutment surface 150 connects the refraction surface 120 and the reflection surface 140, and is perpendicular to the light-emission surface 110 and the light incident surface 130, so that the light guide components adjacent to each other abut against each other at the abutment surface 150.

Herein, for convenience of description, three directions perpendicular to each other are defined: “extension direction”, “horizontal direction” and “vertical direction”. The “extension direction” refers to the direction in which the light guide component 100 extends with the cross section of the light guide component keeping constant (i.e. the direction perpendicular to the paper surface in the figure); the “horizontal direction” refers to a direction parallel to the light-emission surface 110 and the light incident surface 130 in the cross section of the light guide component (i.e. the left and right direction in the figure), and the “vertical direction” refers to a direction perpendicular to the light-emission surface 110 and the light incident surface 130 in the cross section of the light guide component (i.e. the up and down direction in the figure).

For example, the light guide component 100 is in a shape of a flat plate expanding in the extension direction and in the horizontal direction.

An overall thickness D0 of the light guide component 100 is a distance that the light guide component 100 extends in the vertical direction, that is, a distance between the light-emission surface 110 and the light incident surface 130. For example, the overall thickness D0 is, for example, in a range of 5 mm-20 mm.

In the embodiments of the disclosure, the refraction surface 120 for example presents as a single arc segment in the cross section of the light guide component. A radius R0 of the single arc segment of the refraction surface 120 for example is in a range of 2 mm-10 mm. For example, the radius of the single arc segment is in a range of (L0/2+0.5) mm to (L0/2+9) mm, where L0 is a width of the splicing seam 300. A first thickness D1 of the refraction surface 120 is a distance that the refraction surface 120 extends in the vertical direction, and the first thickness D1 for example is in a range of 2 mm-8 mm. A first width L1 of the refraction surface 120 is a distance that the refraction surface 120 extends in the horizontal direction, and the first width L1 for example is in a range of 2 mm-10 mm.

In the embodiments of the disclosure, for example, the reflection surface 140 presents as a straight line segment in the cross-sectional view of FIG. 3. A second thickness D2 of the reflection surface 140 is a distance that the reflection surface 140 extends in the vertical direction, and the second thickness D2 for example is in a range of 2 mm-16 mm. A second width L2 of the reflection surface 140 is a distance that the reflection surface 140 extends in the horizontal direction. For example, the second width L2 is in a range of 0.64 mm-2.15 mm. For example, the second width L2 is in a range of L0/2 mm to (L0/2+0.2) mm, where L0 is the width of the splicing seam 300.

In the embodiments of the disclosure, for example, a length of the abutment surface 150 is in a range of 0.3-1.0 mm. As illustrated in FIG. 3, two adjacent light guide components 100 are arranged symmetrically to each other, so that the abutment surfaces 150 of the two adjacent light guide components 100 face each other and abut against each other. The abutment surface 150 facilitates to eliminate a sharp angle generated in the case where the refraction surface 120 and the reflection surface 140 are directly connected to each other, and further facilitates accurate mutual positioning and reliable assembly of the two adjacent light guide components 100. In addition, the abutment surface 150 is further used to position the light guide component 100 with respect to other components. For example, the abutment surface 150 is aligned with a bezel in the splicing seam 300 to position the light guide component 100 with respect to the display panel 200. In some other embodiments, the abutment surface 150 may be omitted. In the case of omitting the abutment surface 150, the refraction surface 120 for example is directly connected to the reflection surface 140.

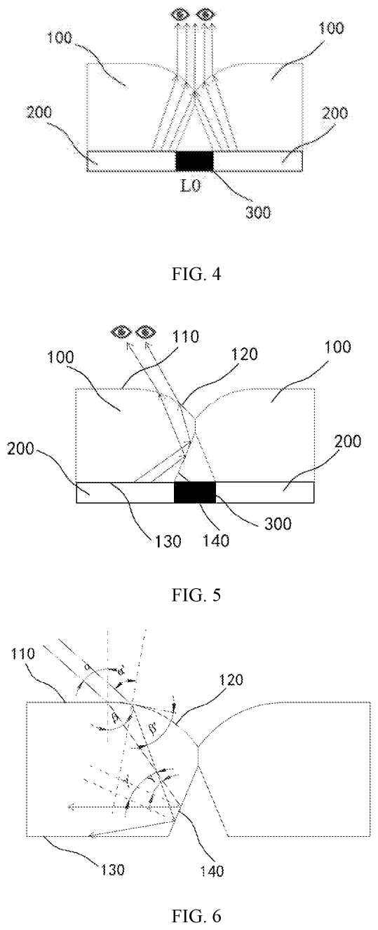

FIG. 4 and FIG. 5 respectively illustrate cross-sectional views of a part of a display device including the two light guide components illustrated in FIG. 3. FIG. 4 illustrates a plurality of first deflected lights of the light guide component 100, and FIG. 5 illustrates a plurality of second deflected lights of the light guide component 100. As illustrated in FIG. 4 and FIG. 5, the display device includes a plurality of display panels 200 (two display panels are illustrated in FIG. 4 and FIG. 5 as an example) and a plurality of light guide components 100 provided on a display side of the display panels 200, and a splicing seam 300 that does not emit light is provided between the two adjacent display panels 200. The light guide components 100 for example are placed to be symmetrically arranged with respect to the splicing seam 300, so that the light incident surface 130 is attached to the display panel 200 and the refraction surface 120 and the reflection surface 140 are adjacent to the splicing seam 300. An orthographic projection of the reflection surface 140 on the display plane of the display panel 200 completely covers the splicing seam 300.

It should be noted that the light guide component 100 may be placed on other light-emission component including a light-emission portion and a non-light-emission portion, so that the light incident surface 130 of the light guide component 100 is placed above the light-emission portion of the light-emission component and the reflection surface 140 of the light guide component 100 is placed above the non-light-emission portion of the light-emission component. In the case where the light-emission component includes the display panel 200, the light-emission portion is the light-emission portion 210 of the display panel 200, and the non-light-emission portion is the splicing seam 300 composed of the non-light-emission portion 220 of the display panel 200 and the bezel.

Each light guide component 100 is configured to allow the first deflected light entering the light incident surface 130 to be projected onto one of the refraction surface 120 and the light-emission surface 110, refracted by one of the refraction surface 120 and the light-emission surface 110 and emitted out of the light guide component; and each light guide component 100 is configured to allow the second deflected light entering the light incident surface 130 to be projected onto the reflection surface 140, reflected to one of the refraction surface 120 and the light-emission surface 110 by the reflection surface 140, refracted by one of the refraction surface 120 and the light-emission surface 110 and emitted out of the light guide component.

In terms of subjective observation, the light guide component 100 eliminates the splicing seam 300 within a certain viewing angle. Specifically, as illustrated in FIG. 4, the light guide component is configured such that the first deflected light entering the light incident surface 130 is projected onto one of the refraction surface 120 and the light-emission surface 110, refracted by one of the refraction surface 120 and the light-emission surface 110 and emitted out of the light guide component, and thus in a smaller viewing angle, the refraction surface 120 of the light guide component 100 refracts the light emitted by the light-emission portion of the display panel 200 adjacent to the splicing seam 300 to be above the splicing seam 300. Specifically, as illustrated in FIG. 5, the light guide component is configured such that second deflected light entering the light incident surface 130 is projected onto the reflection surface 140, reflected to one of the refraction surface 120 and the light-emission surface 110 by the reflection surface 140, refracted by one of the refraction surface 120 and the light-emission surface 110 and emitted out of the light guide component, and thus in a larger viewing angle, the reflection surface 140 of the light guide component 100 reflects the light emitted by the light-emission portion of the display panel 200 adjacent to the splicing seam 300 to one of the refraction surface 120 and the light-emission surface 110, and then the light is refracted by one of the refraction surface 120 and the light-emission surface 110 and emitted in a large angle. Therefore, in terms of subjective observation, within a certain viewing angle, the luminous intensity at the splicing seam 300 is increased, thereby eliminating the splicing seam 300. Therefore, when the viewer's eyes (or other light receivers) view the image displayed on the display panel 200 through the light guide component 100 provided on the display side, the viewer's eyes do not visually observe the splicing seam 300 between the display panels 200, thereby improving the viewer's viewing experience.

By appropriately designing the outline and size of each portion of the light guide component 100, the light guide component 100 is configured such that upon observing each point on the refraction surface 120 and the light-emission surface 110 on the display side where the upper light guide portion is located in a viewing angle smaller than a first threshold angle, at least one of the first deflected light and the second deflected light is observed. Therefore, the light guide component 100 eliminates the splicing seam 300 in the viewing angle smaller than the first threshold angle. For example, the first threshold angle is 90°, 80°, 70°, 60°, 50°, 40°, etc. In the case where the first threshold angle is 90°, the light guide component 100 allows the splicing seam 300 to be eliminated in all viewing angles, so as to achieve the subjective feeling that no splicing seam 300 is observed visually and achieve the complete display of the spliced image in all viewing angles.

In the embodiments of the disclosure, for example, the light guide component 100 is an integral structure. For example, the material of the light guide component 100 is a transparent material such as glass, polycarbonate (PC), polymethyl methacrylate (PMMA), etc. Compared with the case where the light guide component is composed of a plurality of separated sub-optical members, in the embodiments of the present disclosure, the light guide component 100 is integral as a whole, so that the light guiding effect of the light guide component 100 is not affected by the assembly and positioning of the plurality of separated sub-optical members, and the manufacturing cost is low. For example, the light guide component 100 is formed by molding.

In some embodiments, the light guide component such as a triangular prism is used to guide an entirety of the display light emitted by the display panel toward the splicing seam, so as to eliminate the splicing seam. However, this solution for eliminating the splicing seam is not applicable to a case where a plurality of display panels are spliced together, such as a case where a plurality of display panels are spliced together in an array, because this solution cannot eliminate all splicing seams around the display panels. In the embodiments of the present disclosure, because the refraction surface 120 of the light guide component 100 presents as a convex curve line segment such as a single arc segment in the cross section of the light guide component 100, the display image emitted by the display panel 200 is enlarged to eliminate the splicing seam 300. The light guide component 100 not only guides the display light, but also enlarges the display image, so that the light guide component 100 improves the display effect, and is especially applicable to eliminate the splicing seams 300 of the plurality of display panels 200 that are spliced together.

In the cross section of the light guide component, the refraction surface 120 extends continuously from the light-emission surface 110, the refraction surface 120 presents as a continuous curve line segment, and angles of tangent lines at respective points of the refraction surface 120 with respect to an extension line of the light-emission surface 110 gradually increase from the light-emission surface 110 to the light incident surface 130, which facilitates to better eliminate the splicing seam 300 and improve the display effect.

In the embodiments of the disclosure, the refraction surface 120 for example presents as a single arc segment in the cross section of the light guide component. The single arc segment facilitates to reduce sudden changes in the angle of light emitted at the refraction surface 120. In other embodiments, the refraction surface 120 for example has other outlines, for example, the refraction surface 120 includes a plurality of arc segments.

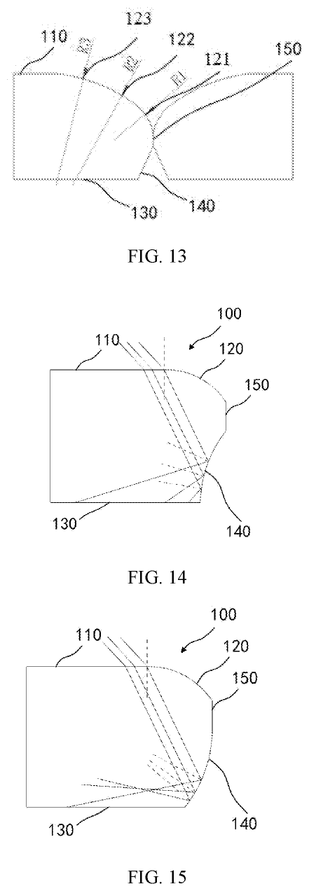

FIG. 13 illustrates another cross-sectional view of a part of the light guide component 100 according to the embodiments of the present disclosure. As illustrated in the cross section of FIG. 13, the light guide component 100 presents to include a third arc segment 123, a second arc segment 122 and a first arc segment 121, which are provided sequentially far away from the light-emission surface 110. A first radius R1 of the first arc segment 121 is smaller than a second radius R2 of the second arc segment 122, and the second radius R2 of the second arc segment 122 is smaller than a third radius R3 of the third arc segment 123. The smaller the radius of the arc segment is, the better the refraction effect is. The first arc segment 121 is configured to improve the elimination effect of the splicing seam 300 in a smaller viewing angle, the second arc segment 122 is configured to improve the elimination effect of the splicing seam 300 in a larger viewing angle, and thus the plurality of arc segments allows the refraction surface 120 to improve the elimination effect of the splicing seam 300 in both a larger viewing angle and a smaller viewing angle. For example, the radiuses of the first arc segment 121, the second arc segment 122 and the third arc segment 123 are respectively in a range of 2 mm-20 mm.

In the embodiments of the disclosure, the reflection surface 140 for example presents as a single straight line segment in the cross-sectional view. Designing the reflection surface 140 presenting as a single straight line segment can avoid image mutation problems such as image distortion and ensure the continuity of the image. In other embodiments, the reflection surface 140 for example have other outlines, for example, the reflection surface 140 is convex or is concave.

FIG. 14 illustrates yet another cross-sectional view of a part of the light guide component 100 according to the embodiments of the present disclosure. As illustrated in FIG. 14, the reflection surface 140 presents as a convex arc segment in the cross-sectional view. FIG. 15 illustrates still another cross-sectional view of a part of the light guide component 100 according to the embodiments of the present disclosure. As illustrated in FIG. 15, the reflection surface 140 presents as a concave arc segment in the cross-sectional view.

The reflection surface 140 for example is configured as a non-totally reflection surface or a totally reflection surface. The reflection surface 140 configured as the totally reflection surface facilitates to eliminate the splicing seam 300 in a larger viewing angle. For example, a totally reflection layer such as a silver reflection layer is provided on the surface of the reflection surface 140 to achieve the total reflection property of the reflection surface 140.

In the case where the reflection surface 140 is configured as the totally reflection surface, the reflection surface 140 is processed through the following steps: forming a screen printing plate, for example, stretching silk fabrics, synthetic
fabrics or metal wires on a frame in a net shape, and forming the screen printing plate by hand engraving paint film or photochemical platemaking;
toning and preparing a reflective material to obtain the reflective material with appropriate reflectivity and color;
providing the light guide component 100, and performing a polishing treatment on the reflection surface 140;
printing the reflective material onto the reflection surface 140 using the screen printing plate, specifically, placing the light guide component 100 on a supporter so that the light guide component 100 moves during printing; and
drying and inspecting.

In addition, the reflection surface 140 for example is attached with a reflective material through an optically transparent adhesive, thereby the reflection surface 140 achieves the totally reflection property. The optically transparent adhesive for example is an OCA (optical clear adhesive) or an OCR (optical clear resin) adhesive. For example, the OCA is a double-sided adhesive tape in which an optical acrylic pressure-sensitive adhesive is provided as a base, and then an optical releasable polyethylene terephthalate (PET) film is respectively attached on an upper side and a lower side of the base. For example, the OCR adhesive is an acrylic resin adhesive or a silicone adhesive, and a curing method of the OCR adhesive is heat curing, ultraviolet light curing, or the like. The optically transparent adhesive prevents or reduces scattering at the reflection surface 140.

In addition, the reflection layer for example is deposited on the reflection surface 140 by a chemical vapor deposition process so that the reflection surface 140 achieves the totally reflection property. The reflection layer for example is a metal layer such as aluminum or gallium, or a metal compound layer such as trimethylaluminum or trimethylgallium.

The length of the abutment surface 150 for example is in a range of 0.3 mm-1 mm.

As mentioned above, by appropriately designing the outline and size of each portion of the light guide component 100, the light guide component 100 eliminates the splicing seam 300 within a viewing angle smaller than the first threshold angle. The above-mentioned content and the content to be discussed below describe the influence of the outline and size of the light guide component 100 on the elimination of the splicing seam 300.

FIG. 6 illustrates another cross-sectional view of a part of the two light guide components 100 in FIG. 3, which illustrates two incident lights respectively incident on the refraction surface 120. As illustrated in FIG. 6, the first incident light and the second incident light are parallel to each other. The first incident light is incident into the light guide component 100 in a first incident angle α at the connection point between the refraction surface 120 and the light-emission surface 110, and is refracted to have a first refraction angle β, and then the first incident light is incident onto the reflection surface 140 and reflected in a first reflection angle γ to be parallel to the light incident surface 130 (i.e., the horizontal direction). The second incident light is incident into the light guide component 100 in a second incident angle α′ at the refraction surface 120, and is refracted at the refraction surface 120 to have a second refraction angle β′, and then the second incident light is incident onto the reflection surface 140 and reflected onto the light incident surface 130 in a second reflection angle γ′. It can be seen that as an incident point of the incident light is far away from the light-emission surface 110, the incident angle of the incident light on the refraction surface 120 increases (α<α′), and the refraction angle (β<β′) of the incident light at the refraction surface 120 and the reflection angle (γ<γ′) at the reflection surface 140 are also increased, so that the incident light is easier to be incident onto the light incident surface 130. The optical path is reversible, and thus for purpose of observing the second deflected light, the farther the point on the refraction surface 120 is away from the light-emission surface 110, the larger the viewing angle, at which the splicing seam 300 is eliminated, is. Therefore, the incident light incident on the connection point between the refraction surface 120 and the light-emission surface 110 will be analyzed below.

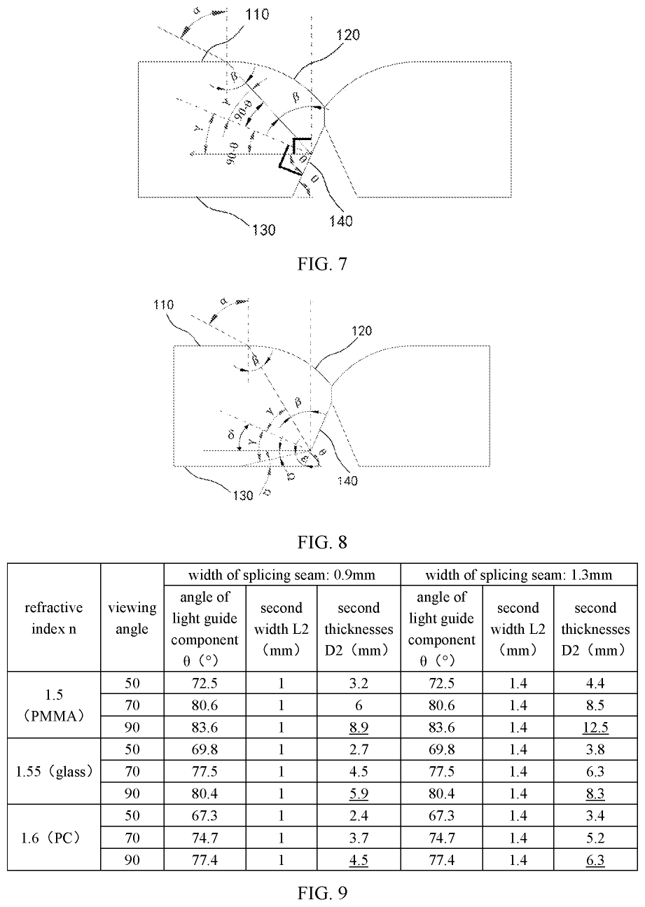

FIG. 7 illustrates another cross-sectional view of a part of the two light guide components 100 in FIG. 3, which illustrates the incident light incident at the connection point between the refraction surface 120 and the light-emission surface 110. As illustrated in FIG. 7, the incident light is incident into the light guide component 100 in the incident angle α at the connection point between the refraction surface 120 and the light-emission surface 110, and is refracted to have the refraction angle β, and then the incident light is incident onto the reflection surface 140 and reflected in the reflection angle γ to be parallel to the light incident surface 130. In addition, FIG. 7 further illustrates an angle θ, which is between the light incident surface 130 and the reflection surface 140, of the light guide component.

According to the law of refraction:

n=sin α/sin β, that is, β=arcsin(sin α/n) (1.1),
where n is the refractive index of the material of the light guide component;
according to the law of reflection:

θ+γ=90°, that is, γ=90°−θ (1.2);
because the incident light is parallel to the incident surface 130 after being reflected
by the reflection surface 140, it is obtained:

γ+γ+β=90° (1.3);

according to the formulas (1.1), (1.2) and (1.3):

(90°−θ)+(90°−θ)+arcsin(sin α/n)=90°, that is,

θ=45°+arcsin(sin α/n)/2 (1.4).

It can be known from the formula (1.4) that the larger the angle θ of the light guide component is and the larger the refractive index n of the material of the light guide component is, the larger the incident angle α is. The optical path is reversible, and thus in order to achieve a larger viewing angle at which the splicing seam 300 is eliminated, it is necessary to increase the angle θ of the light guide component or choose the transparent material with a high refractive index, such as PC, etc.

For example, in the case where the material of the light guide component 100 is PC, the refractive index of the material is n=1.6; and in this case, if the splicing seam being eliminated in all viewing angles within 90° is desired to be achieved, the minimum angle θ of the light guide component is 45°+arcsin(sin 90°/1.6)/2=64.3°. For example, in the case where the material of the light guide component 100 is PMMA, the refractive index of the material is n=1.5; and in this case, if the splicing seam being eliminated in all viewing angles within 90° is desired to be achieved, the minimum angle θ of the light guide component is θ=45°+arcsin(sin 90°/1.5)/2=65.9°.

FIG. 8 illustrates another cross-sectional view of a part of the two light guide components 100 in FIG. 3, which illustrates another incident light incident at the connection point between the refraction surface 120 and the light-emission surface 110. As illustrated in FIG. 8, the incident light is incident into the light guide component 100 in the incident angle α at the connection point between the refraction surface 120 and the light-emission surface 110, and is refracted to have the refraction angle β, and then the incident light is incident onto the reflection surface 140 and is reflected in the reflection angle γ to have an angle Ω with respect to the incident surface 130 (the horizontal direction). In addition, FIG. 8 further illustrates an angle ε between the incident light and the reflection surface 140 after the incident light being reflected at the reflection surface 140, and the angle θ, which is between the light incident surface 130 and the reflection surface 140, of the light guide component.

In the case where the reflection surface 140 is the non-totally reflection surface, assuming that the incident light is incident at the reflection surface 140 in a reflection critical angle, the analysis is as follows:
according to the law of refraction:

n=sin α/sin β, that is, β=arcsin(sin α/n) (2.1),
where n is the refractive index of the material of the light guide component;
according to the law of total reflection:

sin γ/sin 90°=n, that is, γ=arcsin(l/n) (2.2);

an auxiliary line parallel to the light incident surface 130 is drawn to obtain:

ββγ+δ=90°, that is, δ=90°−β−γ (2.3);

θ+δ=90°, that is, θ=90°−δ (2.4);

the formulas (2.1), (2.2) and (2.3) are substituted into the formula (2.4) to obtain:

θ=arsin(sin α/n)+arcsin(l/n) (2.5).

According to the formula (2.5), the larger the angle θ of the light guide component is, the larger the incident angle α is; and the larger the refractive index n of the material of the light guide component is, the larger the incident angle α is.

In the case where the reflection surface 140 is the totally reflection surface, the analysis of the incident light is as follows:

according to the law of refraction:

n=sin α/sin β, that is, β=arcsin(sin α/n) (3.1),
where n is the refractive index of the material of the light guide component;
according to the law of reflection:

ε+γ=90°, that is, ε=90°−γ (3.2);
an auxiliary line parallel to the light incident surface 130 is drawn to obtain:

θ=Ω+ε, that is, ε=θ+Ω (3.3);

β+γ+(γ−Ω)=90°, that is, γ=(90°−β+Ω)/2 (3.4);
according to the formulas (3.2) and (3.3):

90°−γ=θ−Ω, that is, θ=90°+Ω−γ (3.5);
the formulas (3.1) and (3.4) are substituted into the formula (3.5) to obtain:

θ=90°+Ω−{90°−arcsin(sin α/n)+Ω}/2,

that is, θ=45°+Ω/2+arcsin(sin α/n)/2 (3.6).

It can be known from the formula (3.6) that in the same viewing angle (the same incident angle α), the angle θ of the light guide component is positively correlated with the angle α The larger the angle Ω is, the stronger the light intensity is, and the better the reinforcement effect in the oblique viewing angle is. The larger the angle θ of the light guide component is, the larger the angle Ω is, and the better the viewing effect in the oblique viewing angle.

FIG. 9 illustrates a table representing the relationship between the refractive index n, the viewing angle (incident angle α), and the angle θ of the light guide component in the case where the reflection surface 140 is the non-totally reflection surface. Here, the width of the splicing seams 300 is respectively set to 0.9 mm and 1.3 mm. The angle θ of the light guide component is obtained according to the formula (2.5). The second width L2 of the reflection surface 140 is set according to the width of the splicing seam 300, and the second thickness D2 of the reflection surface 140 is obtained according to the angle θ of the light guide component.

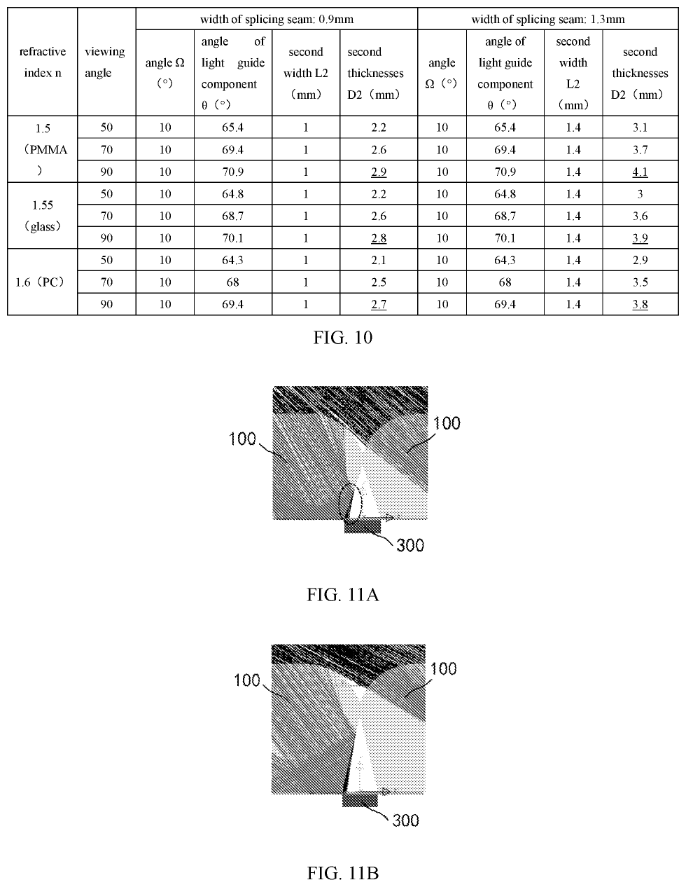

FIG. 10 illustrates a table representing the relationship between the refractive index n, the viewing angle (incident angle α), and the angle θ of the light guide component in the case where the reflection surface 140 is the totally reflection surface. Here, the angle Ω is set to 10°, and the width of the splicing seam 300 is respectively set to 0.9 mm and 1.3 mm. The angle θ of the light guide component is obtained according to the formula (3.6). The second width L2 of the reflection surface 140 is set according to the width of the splicing seam 300, and the second thickness D2 (D2=tan θ*L2) of the reflection surface 140 is obtained according to the angle θ of the light guide component.

It can be known from FIG. 9 and FIG. 10 that:
under the same refractive index n, the larger the angle θ of the light guide component is, the larger the viewing angle is;
under the same viewing angle, the refractive index n is inversely related to the angle θ of the light guide component; and
compared with the case where the reflection surface 140 is the non-totally reflection surface, the case where the reflection surface 140 is the totally reflection surface facilitates to reduce the angle θ of the light guide component and the second thickness D2, which is beneficial to reduce the thickness and material cost of the light guide component 100.

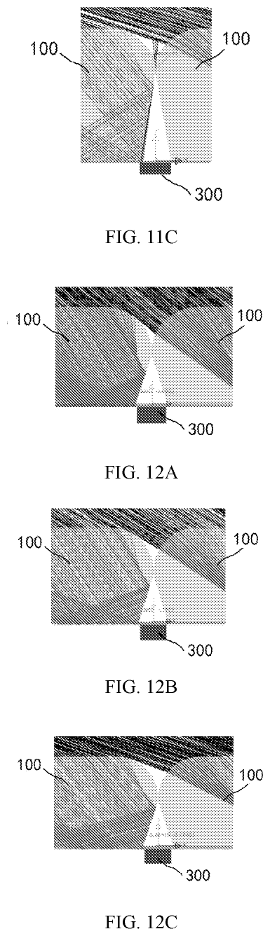

FIG. 11A-FIG. 11C respectively illustrate optical path simulation diagrams of the light guide component 100 under different widths LO of the splicing seam, different viewing angles, different second thicknesses D2 and different second widths L2 in the case where the reflection surface 140 is the non-totally reflection surface.

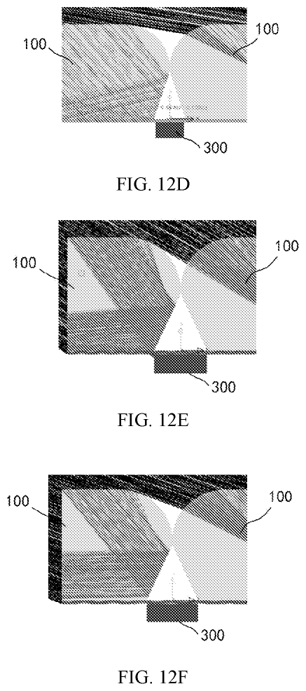

FIG. 12A-FIG. 12F respectively illustrate optical path simulation diagrams of the light guide component 100 under different widths L0 of the splicing seam, different viewing angles, different second thicknesses D2 and different second widths L2 in the case where the reflection surface 140 is the totally reflection surface.

FIG. 11A illustrates an optical path simulation diagram of the light guide component 100 in the case where the reflection surface 140 is the non-totally reflection surface, the viewing angle is 45°, the width L0 of the splicing seam is 0.9 mm, the second width L2 is 1 mm, and the second thickness D2 is 4 mm. As illustrated in FIG. 11A, a portion of the light is refracted at the reflection surface 140 (in the dotted circle) and emitted out of the light guide component 100. The optical path is reversible, a region of the splicing seam 300 where the portion of the light is incident is not compensated, and the region of the splicing seam can be seen.

FIG. 12A-FIG. 12D respectively illustrate optical path simulation diagrams of the light guide component 100 in the case where the reflection surface 140 is the totally reflection surface, the width of the splicing seam L0 is 0.9 mm, the second width L2 is 1 mm, the second thickness D2 is 4 mm, and the viewing angles are respectively 50°, 60°, 70° and 80°. It can be seen from FIG. 12A-FIG. 12D that in the case where the reflection surface 140 is the totally reflection surface, the splicing seam 300 is eliminated in all viewing angles.

FIG. 11B illustrates an optical path simulation diagram of the light guide component 100 in the case where the reflection surface 140 is the non-totally reflection surface, the width L0 of the splicing seam is 1.3 mm, the second width L2 is 1.4 mm, the second thickness D2 is 6 mm, and the viewing angle is 60°. FIG. 11C illustrates an optical path simulation diagram of the light guide component 100 in the case where the reflection surface 140 is the non-totally reflection surface, the width L0 of the splicing seam is 1.3 mm, the second width L2 is 1.4 mm, the second thickness D2 is 8 mm, and the viewing angle is 70°. FIG. 12E and FIG. 12F respectively illustrate optical path simulation diagrams of the light guide component 100 in the case where the reflection surface 140 is the totally reflection surface, the width L0 of the splicing seam is 1.3 mm, the second width L2 is 1.4 mm, the second thickness D2 is 4 mm, and the viewing angles are respectively 60° and 70°.

It can be seen from FIG. 11A-FIG. 11C and FIG. 12A-FIG. 12F that under the same width of the splicing seam and the same viewing angle, compared with the case where the reflection surface 140 is the non-totally reflection surface, the case where the reflection surface 140 is the totally reflection surface facilitates to reduce the second thickness D2, thereby reducing the overall thickness D0 of the light guide component 100.

Based on the analysis of the above formulas and the optical path simulation, the design of the outline and size of the light guide component 100 for example is carried out as follows:
the second width L2 is set according to the width L0 of the splicing seam,
if it is desired to reduce the thickness of the light guide component 100, then a material with a large refractive index (such as PC) is chosen, the reflection surface 140 is set as the totally reflection surface, and the maximum viewing angle, at which the splicing seam is eliminated, is appropriately reduced according to requirements (for example, the maximum viewing angle is set as 70° or 80°);
if it is desired to achieve the maximum viewing angle, at which the splicing seam is eliminated, as large as possible, then a material with a large refractive index (such as PC) is chosen, the reflection surface 140 is set as the totally reflection surface, and the second thickness D2 (that is, the angle θ of the light guide member) is appropriately increased according to requirements.

Some embodiments of the present disclosure further provide a display device, and the display device includes a plurality of display panels 200 and the above-mentioned light guide component 100, and the splicing seam 300 that does not emit light is provided between two adjacent display panels 200. Because the first deflected light and the second deflected light of the display light emitted by the display panel 200 pass through the light guide component 100, the dark region, caused by the splicing seam 300, of the display device is eliminated, and the display effect of the display device is improved.

For example, the light guide component 100 is arranged on the display side of each display panel 200, so that the light incident surface 130 of the light guide component 100 is attached to the display panel 200, the refraction surface 120 and the reflection surface 140 are adjacent to the splicing seam 300, two adjacent light guide components 100 are arranged symmetrically with respect to the splicing seam 300, and the orthographic projections of the reflection surfaces 140 of two adjacent light guide components 100 on the display plane of the display panel 200 completely covers the splicing seam 300.

Some embodiments of the present disclosure further provide a manufacturing method for manufacturing the above-mentioned display device, and the method includes the following steps:
providing a plurality of display panels 200, in which two adjacent display panels 200 are spliced and the splicing seam 300 is provided between the two adjacent display panels 200;
providing the light guide component 100; and
attaching the light guide component 100 onto the display side of the display panel 200.

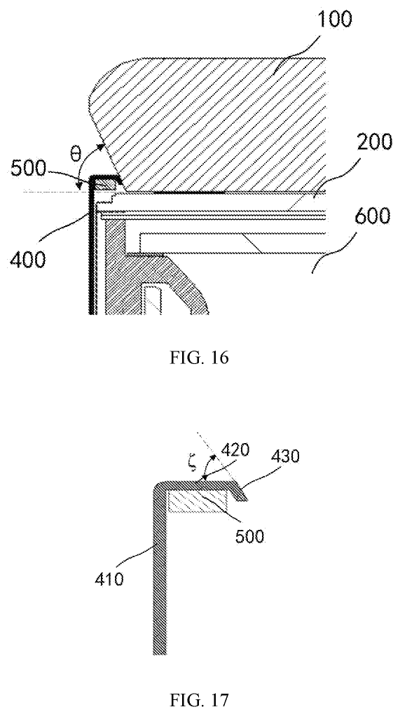

FIG. 16 illustrates a cross-sectional view of a part of the display device according to the embodiments of the present disclosure. FIG. 17 illustrates a cross-sectional view of a bezel 400 and a spacer 500 in FIG. 16.

As illustrated in FIG. 16-FIG. 17, the display device includes the display panel 200, the light guide component 100 provided on the display side of the display panel 200, and a bezel 400 surrounding the display panel 200. The bezel 400 includes a first bezel segment 410, a second bezel segment 420, and a third bezel segment 430. The first bezel segment 410 surrounds the display panel 200 and extends in a vertical direction perpendicular to the display plane of the display panel 200; the second bezel segment 420 extends in a horizontal direction from the first bezel segment 410 toward an interior of the display panel 200; and the third bezel segment 430 extends from the second bezel segment 420 toward the interior of the display panel 200. The second bezel segment 420 and the third bezel segment 430 are on the display side of the display panel 200. A spacer 500 is attached to a side of the second bezel segment 420 of the bezel 400 facing the display panel 200 to provide a buffer function between the bezel 400 and the non-light-emission portion of the display panel 200. The reflection surface 140 of the light guide component 100 abuts against the third bezel segment 430 to position the light guide component 100 with respect to the display panel 200. A bezel bent angle between the third bezel segment 430 and the display plane of the display panel 200 is equal to the angle θ of the light guide component which is between the light incident surface 130 and the reflection surface 140. A space surrounded by the bezel 400 for example is used to accommodate structures such as a backlight unit 600, a circuit board, etc.

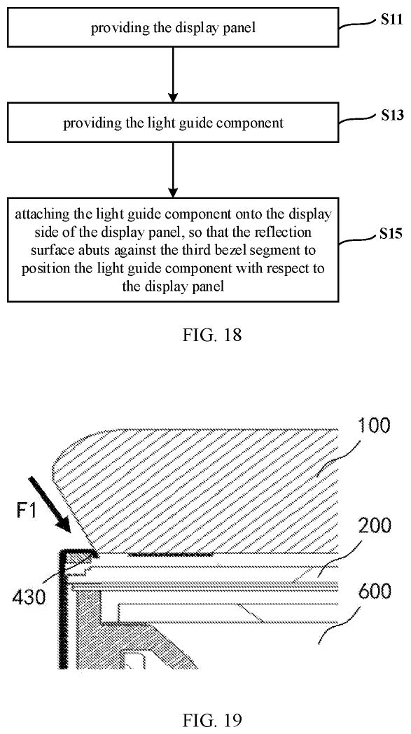

FIG. 18 illustrates a flowchart for manufacturing the display device illustrated in FIG. 16, and FIG. 19 illustrates another cross-sectional view of the display device illustrated in FIG. 16, which illustrates a process of installing the light guide component 100.

As illustrated in FIG. 19, the method for manufacturing the display device includes the following steps:
step S11, providing the display panel 200, in which the splicing seam 300 that does not emit light is formed between two adjacent display panels 200;
step S13, providing the light guide component 100; and
step S15, attaching the light guide component 100 onto the display side of the display panel 200, so that the reflection surface 140 abuts against the third bezel segment 430 to position the light guide component 100 with respect to the display panel 200.

Because the bezel bent angle is equal to the angle θ of the light guide component, the light guide component 100 is conveniently positioned with respect to the display panel 200, and the requirements for installing equipment are reduced.

For example, the attaching the light guide component 100 onto the display side of the display panel 200 includes:
attaching an OCA tape to the light guide component 100 at a position close to a connection point of the light incident surface 130 and the reflection surface 140 of the light guide component 100, in which a distance between the edge of the OCA tape and the connection point is about 2 mm, and a width of the OCA tape is about 5 mm;
in order that the reflection surface 140 of the light guide component 100 abuts against the third bezel segment 430 of the bezel 400, moving the light guide component 100 on the display side (the upper side) of the display panel 200 toward the display panel 200 (for example, along the direction indicated by the arrow F1, so that the reflection surface 140 slides on the third bezel segment 430), until the OCA tape bonds the light guide component 100 to the display panel (as illustrated in FIG. 19); and
applying a pressure on the light guide component 100 toward the display panel 200 for a period of time, so that the light guide component 100 is firmly bonded to the display panel 200.

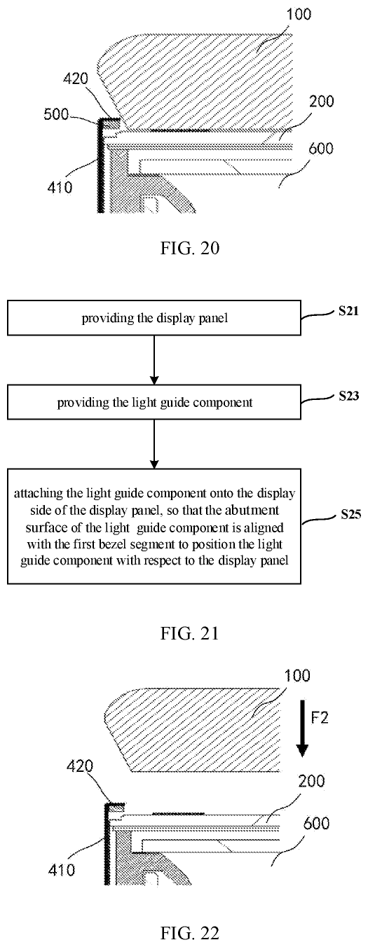

FIG. 20 illustrates yet another cross-sectional view of a part of the display device according to the embodiments of the present disclosure.

As illustrated in FIG. 20, the display device includes the display panel 200, the light guide component 100 provided on the display side of the display panel 200, and the bezel 400 surrounding the display panel 200. The bezel 400 includes the first bezel segment 410 that surrounds the display panel 200 and extends in the vertical direction perpendicular to the display plane of the display panel 200, and the second bezel segment 420 that extends in the horizontal direction from the first bezel segment 410 toward the interior of the display panel 200. The first bezel segment 410 is aligned with the abutment surface 150 of the light guide component 100. The space surrounded by the bezel 400 for example is used to accommodate structures such as the backlight unit 600 and the circuit board.

FIG. 21 illustrates a flowchart for manufacturing the display device illustrated in FIG. 20, and FIG. 22 illustrates another cross-sectional view of the display device illustrated in FIG. 20, which illustrates a process of installing the light guide component 100.

As illustrated in FIG. 21, the method for manufacturing the display device includes the following steps:
step S21, providing the display panel 200, in which the splicing seam 300 that does not emit light is formed between two adjacent display panels 200;
step S23, providing the light guide component 100; and
step S25, attaching the light guide component 100 onto the display side of the display panel 200, so that the abutment surface 150 of the light guide component 100 is aligned with the first bezel segment 410 to position the light guide component 100 with respect to the display panel 200.

The abutment surface 150 is aligned with the first bezel segment 410 to position the light guide component 100 with respect to the display panel 200, so that it is convenient to position the light guide component 100 with respect to the display panel 200. For example, a manipulator is used for attaching the light guide component 100 onto the display side of the display panel 200 under the guidance of monitoring image, and a high assembly precision is achieved. In the method of FIG. 21, the bezel 400 does not need a bending treatment. In the method of FIG. 21, a gap is between the reflection surface 140 and the bezel 400; however, the present disclosure is not limited thereto, and in other embodiments, the bezel 400 with the third bezel segment 430 is further used to guide the light guide component 100.

For example, the attaching the light guide component 100 onto the display side of the display panel 200 includes:
grabbing the light guide component 100 with the manipulator, and coating the OCR adhesive at a position close to the connection point of the light incident surface 130 and the reflection surface 140 of the light guide component 100, in which the distance between an edge of the adhesive-coated region and the connection point is about 2 mm (about 4.6 mm from the outer edge of the bezel 400), and an width of the OCR adhesive region is about 5 mm;
under the guidance of an image sensor such as a photoelectric coupler device (such as CCD), moving the light guide component 100 on the display side (the upper side) of the display panel 200 toward the display panel 200 (for example, in the direction indicated by the arrow F2, that is, the vertical direction), and aligning the abutment surface 150 with the first bezel segment 410 (the outer edge of the first bezel segment 410) until the OCR adhesive bonds the light guide component 100 to the display device (as illustrated in FIG. 22); and
applying the pressure on the light guide component 100 toward the display panel 200 for a period of time, so that the light guide component 100 is firmly bonded to the display panel 200.

The scope of the present disclosure is not limited by the embodiments as described above, but by the appended claims and their equivalents.

1: A light guide component, comprising:
an upper light guide portion, comprising a light-emission surface and a refraction surface; and
a lower light guide portion, arranged opposite to the upper light guide portion, and the lower light guide portion comprising a light incident surface and a reflection surface, wherein
the light-emission surface and the light incident surface are arranged substantially parallel to each other, and the refraction surface and the reflection surface are respectively arranged at an edge of the light guide component;
the light guide component is configured to allow a first deflected light entering the light incident surface to be projected onto one of the refraction surface and the light-emission surface, refracted by one of the refraction surface and the light-emission surface and emitted out of the light guide component; and
the light guide component is configured to allow a second deflected light entering the light incident surface to be projected onto the reflection surface, reflected to one of the refraction surface and the light-emission surface by the reflection surface, refracted by one of the refraction surface and the light-emission surface and emitted out of the light guide component.

2: The light guide component according to claim 1, wherein the light guide component is configured such that:
upon observing each point on the light-emission surface and the refraction surface on a side where the upper light guide portion is located in a viewing angle smaller than a first threshold angle, at least one of the first deflected light and the second deflected light is observed.

3: The light guide component according to claim 1, wherein the light guide component is in a shape of a flat plate.

4: The light guide component according to claim 1, wherein
the light guide component extends in an extension direction with a cross section of the light guide component keeping constant; and
in the cross section of the light guide component, the refraction surface presents as a convex curve line segment.

5: The light guide component according to claim 4, wherein
in the cross section of the light guide component, the refraction surface extends continuously from the light-emission surface, the refraction surface presents as a continuous curve line segment, and angles of tangent lines at respective points of the refraction surface with respect to an extension line of the light-emission surface gradually increase from the light-emission surface to the light incident surface.

6: The light guide component according to claim 5, wherein
in the cross section of the light guide component, the refraction surface presents as a single arc segment.

7: The light guide component according to claim 6, wherein
a radius of the single arc segment is in a range of 2 mm-10 mm.

8: The light guide component according to claim 5, wherein
in the cross section of the light guide component, the refraction surface presents to comprise a plurality of arc segments, and a radius of an arc segment far away from the light-emission surface is smaller than a radius of an arc segment close to the light-emission surface.

9: The light guide component according to claim 8, wherein
in the cross section of the light guide component, the plurality of arc segments comprise a third arc segment, a second arc segment and a first arc segment which are provided sequentially far away from the light-emission surface, a radius of the first arc segment is smaller than a radius of the second arc segment, and the radius of the second arc segment is smaller than a radius of the third arc segment.

10: The light guide component according to claim 8, wherein
radiuses of the plurality of arc segments are respectively in a range of 2 mm-20 mm.

11: The light guide component according to claim 1, wherein
in a cross section of the light guide component, the reflection surface presents as a single straight line segment, a convex arc segment, or a concave arc segment; and
the reflection surface comprises a totally reflection surface.

12. (canceled)

13: The light guide component according to claim 1, wherein
in a cross section of the light guide component, an overall thickness of the light guide component is in a range of 5 mm-20 mm, and the overall thickness is a distance between the light-emission surface and the light incident surface;
in a cross section of the light guide component, a first width of the refraction surface is in a range of 2 mm-10 mm, a first thickness of the refraction surface is in a range of 2 mm-8 mm, the first width is a distance that the refraction surface extends in a direction parallel to the light incident surface, and the first thickness is a distance that the refraction surface extends in a direction perpendicular to the light incident surface;
in a cross section of the light guide component, a second width of the reflection surface is in a range of 0.64 mm-2.15 mm, a second thickness of the reflection surface is in a range of 2 mm-16 mm, the second width is a distance that the reflection surface extends in a direction parallel to the light incident surface, and the second thickness is a distance that the reflection surface extends in a direction perpendicular to the light incident surface.

14-15. (canceled)

16: The light guide component according to claim 1, further comprising an abutment surface, wherein
the abutment surface is connected between the refraction surface and the reflection surface and is perpendicular to the light-emission surface and the light incident surface, so that the light guide component and an adjacent light guide component abut against each other through the abutment surface.

17: The light guide component according to claim 16, wherein
a length of the abutment surface is in a range of 0.3 mm-1 mm.

18: A display device, comprising:
a plurality of display panels, wherein a splicing seam that does not emit light is provided between two adjacent display panels; and
the light guide component according to claim 1, wherein the light guide component is provided on a display side of each of the plurality of display panels, so that the light incident surface is attached to the display panel, the refraction surface and the reflection surface are close to the splicing seam, two adjacent light guide components are arranged symmetrically with respect to the splicing seam, and an orthographic projection of the reflection surface on a display plane of the display panel completely covers the splicing seam.

19: The display device according to claim 18, wherein
the splicing seam comprises a plurality of bezels, each bezel surrounds one of the plurality of display panels, and each bezel comprises a first bezel segment surrounding the display panel and extending perpendicular to the display plane of the display panel, a second bezel segment extending from the first bezel segment toward an interior of the display panel, and a third bezel segment extending from the second bezel segment toward the interior of the display panel; and
the second bezel segment and the third bezel segment are on the display side of the display panel, the reflection surface abuts against the third bezel segment, and a bezel bent angle between the third bezel segment and the display plane is equal to an angle of the light guide component between the light incident surface and the reflection surface.

20: The display device according to claim 18, wherein
the light guide component further comprises an abutment surface, the abutment surface is connected between the refraction surface and the reflection surface and is perpendicular to the light-emission surface and the light incident surface, and two adjacent light guide components abut against each other through the abutment surface; and
the splicing seam comprises a plurality of bezels, each bezel surrounds one of the plurality of display panels, and each bezel comprises a first bezel segment surrounding the display panel and extending perpendicular to the display plane of the display panel.

21: The display device according to claim 18, wherein
in a cross section of the light guide component, a second width of the reflection surface is in a range of L0/2 mm to (L0/2+0.2) mm, and L0 is a width of the splicing seam;
in the cross section of the light guide component, the refraction surface presents as a single arc segment, a radius of the single arc segment is in a range of (L0/2+0.5) mm to (L0/2+9) mm, and L0 is a width of the splicing seam.

22. (canceled)

23: A method for manufacturing the display device according to claim 19, comprising:
providing the plurality of display panels, wherein the splicing seam that does not emit light is formed between two adjacent display panels;
providing the light guide component; and
attaching the light guide component onto the display side of the display panel, so that the reflection surface abuts against the third bezel segment to position the light guide component with respect to the display panel.

24: A method for manufacturing the display device according to claim 20, comprising:
providing the plurality of display panels, wherein the splicing seam that does not emit light is formed between two adjacent display panels;
providing the light guide component; and
attaching the light guide component onto the display side of the display panel, so that the abutment surface is aligned with the first bezel segment to position the light guide component with respect to the display panel.
